(19) United States
(12) Patent Application Publication
(10) Pub. No.: US 2020/0170225 A1
(43) Pub. Date: Jun. 4, 2020

(54) CHICKEN UNLOADER

(71) Applicant: Adelfo Andres Anguiano Jaimes, Siler City, NC (US)

(72) Inventor: Adelfo Andres Anguiano Jaimes, Siler City, NC (US)

(21) Appl. No.: 16/206,406

(22) Filed: Nov. 30, 2018

(51) Int. Cl. A01K 45/00; A01K 29/00; A61D 1/02

(52) U.S. Cl. CPC A01K 45/005; A01K 2227/30; A61D 1/025; A01K 29/005

(57) ABSTRACT

An unloader for a poultry inspection and vaccination transporter. The unloader has a horizontally disposed unloader bar that is operable between a carry position, in which the poultry is carried on a hanger of the transporter, and an unload position, in which vertical displacement of the unloader bar between the poultry and the hanger urges the poultry from its suspended position in the hanger to release the poultry from the hanger. The unloader bar may be operated by cooperative engagement of a vertically disposed shaft to which the unloader bar is connected, with an ramp assembly disposed in a traversal path of the transporter.

### BACKGROUND OF THE INVENTION

The present invention relates to poultry processing, and more particularly, poultry processing for vaccination or inspection procedures.

During poultry inspection and vaccination operations, it is customary to maintain separation between the poultry that has been examined and vaccinated, from those that have not been vaccinated, and more particularly, segregate those that have failed an inspection from either group.

A transporter, such as a poultry carousel, is an apparatus that is utilized to carry the poultry between an input side, where poultry awaiting a procedure are marshalled, and an output side, where the treated poultry are released following completion of the procedure. With a carousel, poultry at an input side are loaded onto a hanger. The carousel is then rotated to carry the bird while the inspection, and/or vaccination procedure is performed. Once the procedure is complete, the bird must be removed from the hanger and released at the output side. Removal can be difficult at times, particularly if the bird is disturbed from receiving a vaccination. Removal of the bird from the hanger can thus take additional time, reducing efficiency, and in some instances, can result in injury to the bird.

As can be seen, there is a need for an apparatus and method for safely and efficiently removing a poultry animal from a poultry transporter, once an inspection or vaccination procedure have been completed.

### SUMMARY OF THE INVENTION

In one aspect of the present invention, an unloader assembly for a poultry inspection and vaccination transporter is disclosed. The transporter has at least one hanger configured to suspend and carry poultry. The unloader assembly includes a horizontally disposed unloader bar that is aligned with a face of the hanger. The unloader bar is carried on a shaft that is disposed for vertical displacement of the unloader bar. An unloader actuator is attached to the shaft. The unloader actuator is operable between a carry position, in which the poultry animal remains suspended on the hanger, and a unload position, in which actuator elevates the unloader bar between the poultry animal and the hanger, such that unloader bar urges the poultry animal from suspension on the hanger.

In some embodiments, a roller assembly is coupled to a bottom end of the shaft. A ramp assembly is aligned with a traversal path of the transporter, such that traversal of the roller assembly across an inclined entry segment of the ramp assembly elevates the shaft. A release segment, having an incline less than that of the entry segment, maintains the unloader bar in the elevated unload position during traversal of the roller assembly across the release segment. In some embodiments, an exit segment, having a declined surface relative the release segment, is provided wherein traversal of the roller assembly across the exit segment lowers the unloader bar.

In some embodiments, one or more collars are attachable to a lower frame of the transporter, the one or more collars are dimensioned to receive the shaft for vertical displacement therein. An anti-sway bar may extend from the shaft, and is oriented to maintain the unloader bar in alignment with the face of the hanger during displacement of the unloader bar. One or more casters may be attached to the anti-sway bar.

An unloader bracket, may be provided that attachable to a lower frame of the transporter, wherein the one or more collars are attached to the bracket.

In other aspects of the invention, an unloader assembly for a poultry inspection and vaccination transporter is disclosed. The transporter has at least one hanger configured to suspend and carry poultry. The unloader assembly includes an unloader bracket adapted to be attached to a frame of the transporter. At least one collar is attached to the unloader bracket. A shaft is carried by the at least one collar, such that the shaft is disposed for vertical displacement within the at least one collar. A horizontally disposed unloader bar is transversely aligned with a face of the hanger. The unloader bar is operable between a carry position, in which the poultry animal remains suspended on the hanger, and a unload position, in which the unloader bar is elevated between the poultry animal and the hanger, such that unloader bar urges the poultry animal from suspension on the hanger.

In some embodiments, a ramp assembly is aligned with a traversal path of the transporter. Traversal of a lower end of the shaft across an inclined entry segment of the ramp assembly elevates the shaft. A release segment, having an incline less than that of the entry segment, maintains the unloader bar in the elevated, unload position, during traversal of the lower end of the shaft across the release segment. An exit segment, having a declined surface relative the release segment, may also be provided. Traversal of the lower end of the shaft across the exit segment lowers the unloader bar to the carry position. A roller may be attached to the lower end of the shaft, such that the roller is interposed between the shaft and the ramp assembly.

These and other features, aspects and advantages of the present invention will become better understood with reference to the following drawings, description and claims.

### BRIEF DESCRIPTION OF THE DRAWINGS

FIG. 1 is perspective view of the poultry carousel and unloader.

FIG. 2 is an outside front elevation view of the poultry unloader with parts broken away.

FIG. 3 is an inside rear perspective view of the poultry unloader with parts broken away.

FIG. 4 is an inside detail perspective view showing a poultry unloader in an idle mode.

FIG. 5 is a detail sectional view with parts shown in cross-section of the poultry unloader in an carry position, shown at line 5-5 of FIG. 3.

FIG. 6 is a side elevation view with parts shown in cross-section of the poultry unloading position, shown at line 6-6 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides an improvement for poultry inspection and vaccination transporter, such as a poultry carousel that safely and efficiently releases a fowl from the carousel hanger. The improved poultry carousel can increase the efficiency of inspection and vaccination procedures while ensuring that the fowl is not injured when removing it from the carousel.

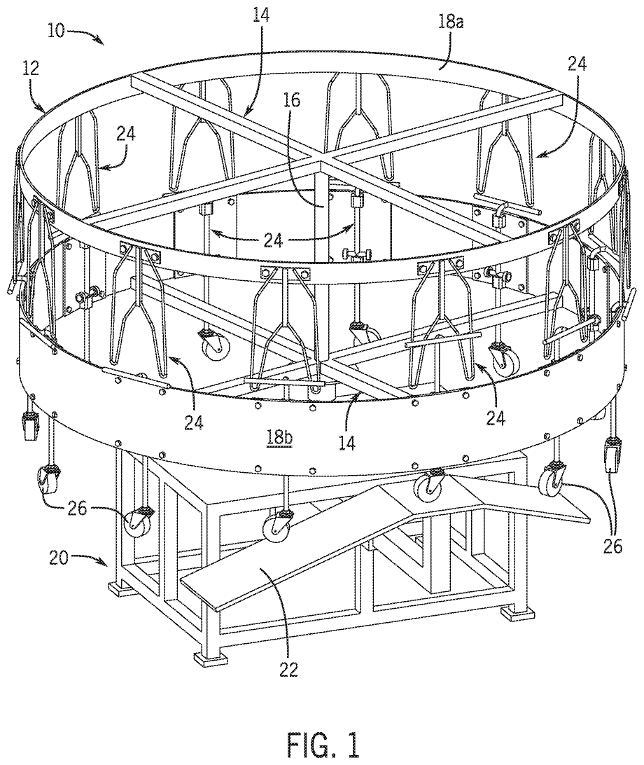

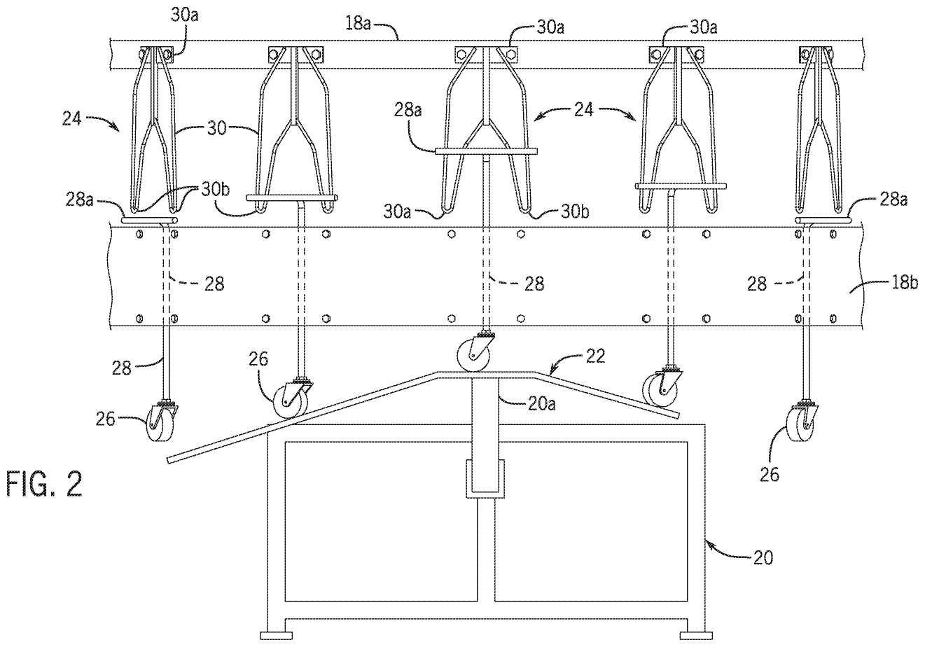

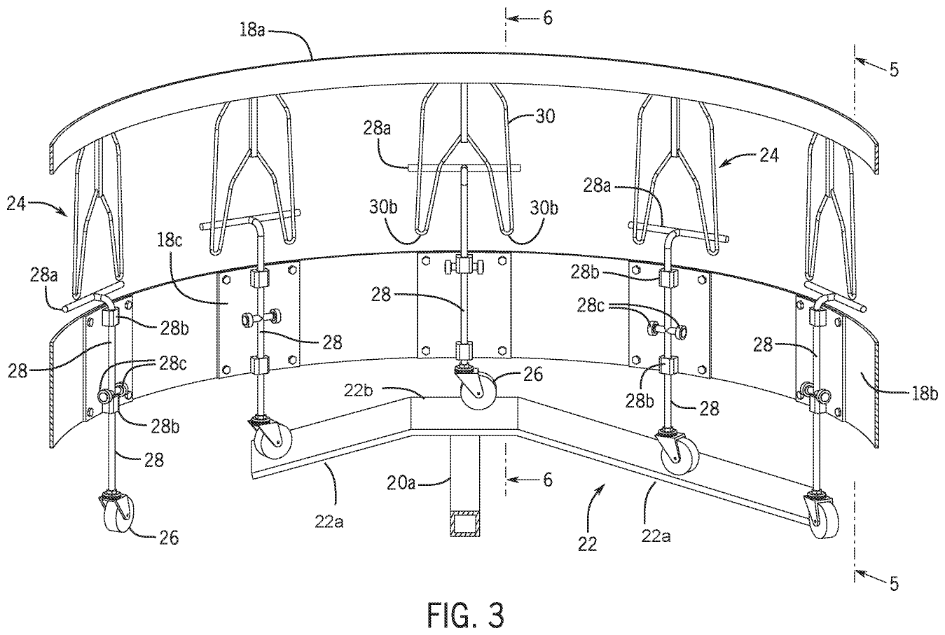

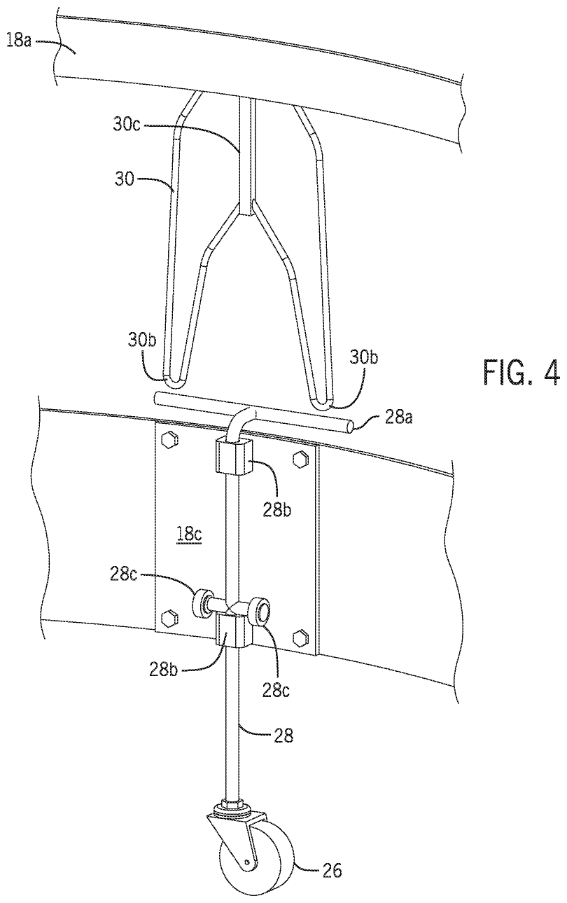

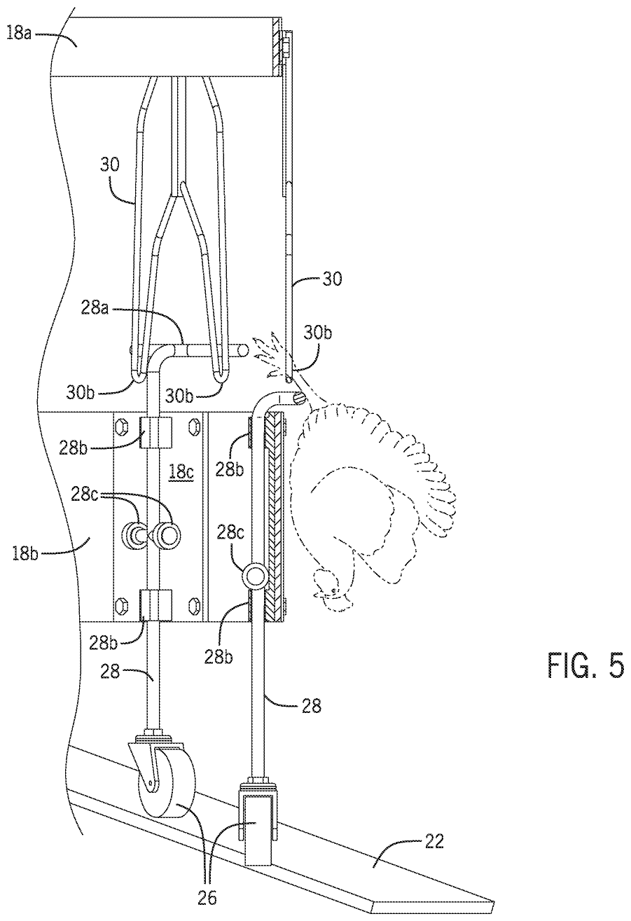

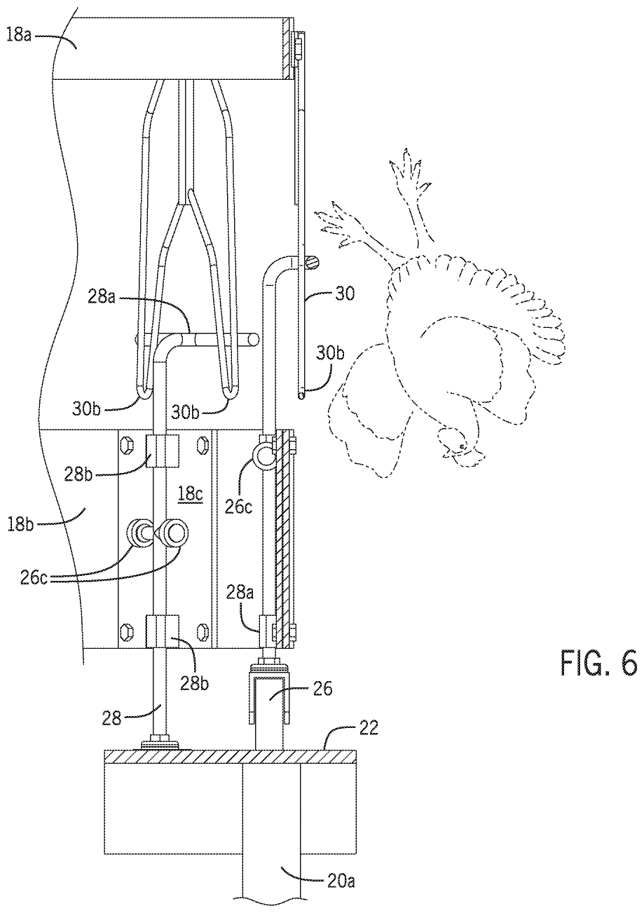

As shown in reference to the Drawings of FIGS. 1-6, an improved poultry carousel unloader 10 of the present invention is shown. The poultry carousel 10 includes a carousel 12 that is supported by one or more structural members 14 for rotation about a central shaft 16. The carousel 12, may include one or more ring structures, such as an upper ring 18a and a lower ring 18b.

A plurality of hanger assemblies 24 are attached to the upper ring 18a, such as by a bracket 30a, so that the hangers 24 are disposed in a spaced apart relationship about the circumference of the upper ring 18a. Each of the plurality of hanger assemblies 24 include a pair of nooks 30b, at a V shaped convergence of one or more arms of the hanger 24. The nooks 30b, may be utilized to hang a poultry animal by its wing shoulders, or its feet, so that the bird is suspended from the carousel 12 by the hanger assembly 24.

The carousel 12 is also fitted with a plurality of unloader assemblies 28, with an unloader assembly 28 provided for each of the plurality of hanger assemblies 24. The unloader assembly 28 is attached to the carousel 12 such that vertical displacement of an unloader bar 28a releases a treated bird from the hanger assembly 24. The unloader bar 28a is aligned with a face of the hanger assembly 24. The unloader assembly 28 may include one or more collars 28b to receive the vertical shaft 28. In some embodiments, and anti sway bar 28c may be fitted with casters to prevent or limit rotation of the unloader bar 28a from an alignment with the hanger assembly 24.

In the non-limiting embodiment shown, the unloader assembly 28 may include a horizontal unloader bar 28a carried on a vertical shaft 28. The vertical shaft 28 may be attached to the lower carousel 18b via a mounting bracket 18c. The unloader bar 28a is operable between a carrying position, in which the poultry are carried by the hanger 24, and an unloading position, in which the unloader bar 28a is elevated so that it is disposed between the suspended bird and the nooks 30b of the hanger 24. During movement of the unloader bar 28a to the unloading position, the unloader bar 28a is urged against the suspended limbs of the poultry so that the suspended limbs are released from the nooks 30b. Once freed, the bird is free to land on the ground at the output side of the carousel 10.

The unloader assembly 28 includes an unloader actuator to selectively position the unloader bar 28b between the carry position and the unloading position. In the non-limiting embodiment shown, the actuator may include a roller, or wheel assembly 26 fitted to a bottom end of the vertical shaft 28 of the unloader assembly. The unloader assembly 28 may be actuated with the movement of the roller assembly 26 across an actuator ramp 22.

The actuator ramp 22 may be supported by a frame assembly 20 and have incline adjustment post 20a to adjustably set the incline of the actuator ramp 22. The actuator ramp 22 may have at least one entry/exit segment 22a, a release segment 22b, where the entry/exit segment 22a is oriented at an incline and the release segment 22b is at a reduced incline or horizontal alignment. In operation, the roller assembly 26 contacts the entry segment 22a. The actuator ramp 22 is aligned with a traversal path of the transporter. In the carousel depicted, the traversal path is a circular path.

As the roller assembly 26 traverses the incline during rotation of the carousel 12, the unloader assembly 28 is gradually elevated to urge the unloader bar 28b against the limbs of the suspended bird. The unloader assembly 28 is maintained at the release position as the roller assembly 26 traverses the release segment 22b to give the bird an opportunity to be released from the hanger 24. As the roller assembly 26 traverses the exit segment 22a, the unloader bar 28b gradually returns to the carry position, to avoid injury to the bird in the event the bird continues to be suspended from the hanger 24. With both an entry segment 22a and an exit segment 22a, the unloader carousel may be operated in either a clockwise or a counterclockwise direction.

As will be appreciated from the benefit of the present disclosure, the manual unloader actuator may be preferable in locations where an alternative power source, such as hydraulics, or electric power may not be readily available. This allows the inspection or vaccination of the poultry in any suitable location where the birds may be marshalled and segregated. When an alternative power source is available, the unloader actuator, may also include one or more of a hydraulic, or electric actuator.

It should be understood, of course, that the foregoing relates to exemplary embodiments of the invention and that modifications may be made without departing from the spirit and scope of the invention as set forth in the following claims.

What is claimed is:

1. An unloader assembly for a poultry inspection and vaccination transporter having at least one hanger configured to suspend and carry a poultry animal, comprising:
a horizontally disposed unloader bar aligned with a face of the hanger, the unloader bar carried on a shaft disposed for vertical displacement of the unloader bar; and
an unloader actuator attached to the shaft, the unloader actuator operable between a carry position, in which the poultry animal remains suspended on the hanger, and a unload position, in which actuator elevates the unloader bar between the poultry animal and the hanger, such that unloader bar urges the poultry animal from suspension on the hanger.

2. The unloader assembly of claim 1, further comprising:
a roller assembly coupled to a bottom end of the shaft; and
a ramp assembly aligned with a traversal path of the transporter, wherein traversal of the roller assembly across an inclined entry segment of the ramp assembly elevates the shaft.

3. The unloader assembly of claim 2, further comprising:
a release segment, having an incline less than that of the entry segment, maintains the unloader bar in the elevated unload position during traversal of the roller assembly.

4. The unloader assembly of claim 3, further comprising:
an exit segment, having a declined surface relative the release segment, wherein traversal of the roller assembly across the exit segment lowers the unloader bar.

5. The unloader assembly of claim 1, further comprising:
one or more collars attachable to a lower frame of the transporter, the one or more collars dimensioned to receive the shaft for vertical displacement therein.

6. The unloader assembly of claim 5, further comprising:
an anti-sway bar extending from the shaft, oriented to maintain the unloader bar in alignment with the face of the hanger during displacement of the unloader bar.

7. The unloader assembly of claim 6, further comprising:
one or more casters attached to the anti-sway bar.

8. The unloader assembly of claim 1, further comprising:
a bracket, attachable to a lower frame of the transporter, wherein the one or more collars are attached to the bracket.

9. An unloader assembly for a poultry inspection and vaccination transporter having at least one hanger configured to suspend and carry a poultry animal, comprising:
an unloader bracket adapted to be attached to a frame of the transporter;
at least one collar attached to the unloader bracket;
a shaft carried by the at least one collar, the shaft disposed for vertical displacement within the at least one collar; and
a horizontally disposed unloader bar is attached to the shaft and is transversely aligned with a face of the hanger, wherein the unloader bar is operable between a carry position, in which the poultry animal remains suspended on the hanger, and a unload position, in which the unloader bar is elevated between the poultry animal and the hanger, such that unloader bar urges the poultry animal from suspension on the hanger.

10. The unloader assembly of claim 9, further comprising:
a ramp assembly aligned with a traversal path of the transporter, wherein traversal of a lower end of the shaft across an inclined entry segment of the ramp assembly elevates the shaft.

11. The unloader assembly of claim 10, the ramp assembly further comprising:
a release segment, having an incline less than that of the entry segment, maintains the unloader bar in the elevated unload position during traversal of the lower end of the shaft across the release segment.

12. The unloader assembly of claim 11, the ramp assembly further comprising:
an exit segment, having a declined surface relative the release segment, wherein traversal of the lower end of the shaft across the exit segment lowers the unloader bar.

13. The unloader assembly of claim 10, further comprising:
a roller attached to the lower end of the shaft, such that the roller is interposed between the shaft and the ramp assembly.
